(19) United States
(12) Patent Application Publication
(10) Pub. No.: US 2011/0051029 A1
(43) Pub. Date: Mar. 3, 2011

(54) DISPLAY DEVICE, ELECTRONIC APPARATUS, AND PROJECTION IMAGING APPARATUS

(75) Inventor: Osamu OKUMURA, Chino-shi (JP)

(73) Assignee: SEIKO EPSON CORPORATION, Tokyo (JP)

(21) Appl. No.: 12/862,873

(22) Filed: Aug. 25, 2010

(30) Foreign Application Priority Data
Sep. 1, 2009 (JP) 2009-201336

(51) Int. Cl. G02F 1/1335; G02B 27/02; G02B 5/04; G02B 5/30; G03B 21/14

(52) U.S. Cl. 349/57; 359/831; 359/493; 353/81

(57) ABSTRACT

A display device includes a display panel, and a prism that is installed on a display face of the display panel and has an inclination face inclined from the display face. An inclination angle of the inclination face of the prism with respect to the display face is set such that an output angle of display light output from the display face and transmitted through the prism is equal to or more than a small angle of an incident angle and a reflection angle of sunlight with respect to the inclination face based on a normal line of the display face.

The entire disclosure of Japanese Patent Application No. 2009-201336, filed Sep. 1, 2009 is expressly incorporated by reference herein.

### BACKGROUND

1. Technical Field

The present invention relates to a display device, an electronic apparatus provided with display device, and a projection imaging apparatus.

2. Related Art

As the display device, a head-up display (HUD) has been developed which is installed in a vehicle to project an image displayed on a display unit to a windshield of the vehicle.

In such a head-up display, it has been known that sunlight entering the display unit through the windshield of the vehicle has various influences.

For example, in JP-A-2007-65011, it is described that when a liquid crystal display is used as the display unit, a polarization member is damaged by the sunlight, and at worst, an image cannot be displayed.

In consideration of the problem, in JP-A-2007-65011, a transreflective member, which transmits display light and reflects infrared light, and a polarization member are provided on the front side of a liquid crystal cell, and they are not parallel to the liquid crystal cell.

Accordingly, the sunlight entering the liquid crystal cell is reflected from the transreflective member, thereby preventing the damage of the polarization member and the liquid crystal cell caused by the heat of the sunlight. In addition, the display light output from the liquid crystal cell is reflected from the transreflective member provided on the front side, and enters the liquid crystal cell again, which is stray light. The stray light can be also prevented.

For example, in JP-A-2007-148092, it is disclosed that sunlight enters a display unit at various angles, the sunlight reflected from the display unit overlaps with the display light according to an incident angle, and thus the image may not be recognized.

In consideration of the problem, in JP-A-2007-148092, an optical member which is provided on the front side of the display unit and enlarges and transmits the image output from the display unit is pivotably configured to vary an angle formed between a projection plane on which the enlarged image is projected and a transmission plane opposed to the projection plane of the optical member. The display unit is provided at an angle such that the sunlight transmitted through the optical member does not perpendicularly enter the display unit.

Accordingly, the optical member is pivoted such that the sunlight and the projection light (display light) do not overlap with each other, and thus it is possible to show a stable image.

In JP-A-2007-65011, a part of the sunlight is reflected and removed by the transreflective member, but there is a problem in that most of the light is transmitted through the transreflective member, is reflected from the surface of the liquid crystal cell, and overlaps with the display light, thereby decreasing contrast.

In JP-A-2007-148092, a mechanism to pivot the optical member is necessary, and a structure thereof is complicated.

For example, when a liquid crystal display device is used as the display unit and the display unit is provided at an angle from the sunlight which is transmitted through the optical member, there is a problem that a real visual angle range of the liquid crystal display device may deviate from a range in which the optimal contrast can be obtained.

### SUMMARY

An advantage of some aspects of the invention is that it provides a display device, an electronic apparatus, and a projection imaging apparatus which are capable of solving at least a part of the above-mentioned problems. The invention can be realized by the following configuration or applications.

### Application 1

According to an aspect of the application, there is provided a display device including a display panel, and a prism that is installed on a display face of the display panel and has an inclination face inclined from the display face, wherein an inclination angle of the inclination face of the prism with respect to the display face is set such that an output angle of display light output from the display face and transmitted through the prism is equal to or more than a small angle of an incident angle and a reflection angle of sunlight with respect to the inclination face based on a normal line of the display face.

With such a configuration, it is hard for the sunlight reflected from the inclination face of the prism or the sunlight transmitted through the prism and reflected from the display face of the display panel to overlap with the output direction of the display light. That is, the display on the display panel is prevented from being hardly seen by the influence of the sunlight reflection. The prism is provided on the display face, and thus it is possible to view an image in a state where optical characteristics such as contrast are optimal when viewing the display panel from the output direction of the display light, even when the output direction of the display light deviates from the normal line direction of the display face. In other words, it is possible to view the image with stable optical characteristics, as compared with the case of viewing the display panel in a state where there is no prism in a direction deviating from the normal line direction.

### Application 2

In the display device of the application, it is preferable that the inclination angle of the inclination face is equal to or less than 30°.

With such a configuration, the color of the display light input from the display face to the prism is prevented from being significantly dispersed by the wavelength dispersion characteristics of the prism. That is, it is possible to obtain stable optical characteristics.

### Application 3

In the display device of the application, when a sum of the incident angle and the reflection angle of the sunlight with respect to the inclination face based on the normal line of the display face is equal to or more than 20° and equal to or less than 50°, the inclination angle of the inclination face with respect to the display face is equal to or more than 6° and equal to or less than 18.5°.

With such a configuration, when the visual angle range based on the normal line of the display face is equal to or more than 20° and equal to or less than 50°, the influence of the sunlight reflection is suppressed and it is possible to obtain a display with high visual angle quality.

### Application 4

In the display device of the application, it is preferable that the prism is provided in close contact with the display face of the display panel.

With such a configuration, it is hard for the sunlight input to the prism to be reflected on the display face, and it is possible to further suppress the influence of the sunlight reflection in the display on the display panel.

### Application 5

In the display device of the application, wherein the prism may be a prism sheet having a plurality of inclination faces inclined and arranged in the same direction.

With such a configuration, it is possible to reduce the thickness of the display device including the prism, as compared with the case of providing the prism having a single inclination face on the display face. Therefore, it is possible to provide a smaller display device.

### Application 6

In the display device of the application, it is preferable that the display panel has a plurality of pixels arranged in a first direction and a second direction intersecting the first direction, and the prism is provided on the display panel such that an extending direction of the plurality of inclination faces intersects the first direction and the second direction.

With such a configuration, it is possible to avoid interference of light between the plurality of inclination faces and the plurality of pixels, and it is possible to obtain a display with high visual angle quality.

### Application 7

In the display device of the application, it is preferable that the display panel has at least a polarization element on the incident side of the sunlight, and the polarization element is provided on the inclination face of the prism.

With such a configuration, the polarization element which is easily heated by absorbing the sunlight is disposed at a position separated from the display face. Accordingly, it is hard for the display panel to be affected by the heat of the sunlight, as compared with the case of disposing the prism on the display face with the polarization element interposed therebetween.

### Application 8

In the display device of the application, it is preferable that the display panel is a liquid crystal panel, initial alignment of liquid crystal molecules in the liquid crystal panel is substantially parallel to the display face, the prism is provided on the display face such that the inclination direction of the inclination face and the initial alignment direction of the liquid crystal molecules intersect with each other based on the normal line of the display face, and the polarization element is provided on the inclination face such that an absorption axis is substantially the same as the initial alignment direction.

With such a configuration, even when the polarization element is disposed on the inclination face of the prism, it is possible to obtain stable optical characteristics for the display on the display panel since the absorption axis and the initial alignment direction of the liquid crystal molecules are substantially the same, regardless of the inclination direction of the inclination face.

### Application 9

According to another aspect of the application, there is provided an electronic apparatus provided with the display device of the applications.

With such a configuration, it is hard to be affected by the sunlight reflection in a predetermined visual angle range, and it is possible to provide the electronic apparatus by which a display state with high visual angle quality can be obtained.

### Application 10

According to a still another aspect of the application, there is provided a projection imaging apparatus provided with the display device of the applications.

With such a configuration, it is hard to be affected by the sunlight reflection in a predetermined visual angle range, and it is possible to provide the projection imaging apparatus by which a projection image with high visual angle quality can be obtained.

### BRIEF DESCRIPTION OF THE DRAWINGS

The invention will be described with reference to the accompanying drawings, wherein like numbers reference like elements.

FIG. 1A is a schematic perspective view illustrating a configuration of a display device according to a first embodiment.

FIG. 1B is a schematic cross-sectional view illustrating the display device according to the first embodiment.

FIG. 2A is a schematic plan view illustrating a configuration of a display panel.

FIG. 2B is a schematic cross-sectional view illustrating the display panel.

FIG. 3 is a schematic plan view illustrating a configuration of pixels.

FIG. 4 is a schematic cross-sectional view of main parts illustrating a structure of pixels.

FIG. 5A is a schematic view illustrating an optical design condition in the display panel.

FIG. 5B is a schematic view illustrating an optical design condition in the display panel.

FIG. 5C is a schematic view illustrating an optical design condition in the display panel.

FIG. 6 is a schematic cross-sectional view illustrating an influence of sunlight in the display device according to the first embodiment.

FIG. 7 is a schematic cross-sectional view illustrating optical disposition of a lighting device and a display panel of a comparative example.

FIG. 8 is a graph illustrating contrast characteristics in the display panel.

FIG. 9 is a graph illustrating contrast characteristics in the display device according to the first embodiment.

FIG. 10 is a schematic cross-sectional view illustrating a configuration of a display device according to a second embodiment.

FIG. 11A is a schematic perspective view illustrating a configuration of a display device according to a third embodiment.

FIG. 11B is a front view illustrating the display device according to the third embodiment.

FIG. 12 is a schematic cross-sectional view illustrating a configuration of the display device according to the third embodiment.

FIG. 13 is a schematic view illustrating the configuration of a head-up display as a projection imaging apparatus.

### DESCRIPTION OF EXEMPLARY EMBODIMENTS

Hereinafter, embodiments of the invention will be described with reference to the drawings. The drawings are appropriately enlarged and reduced such that described parts can be recognized.

### First Embodiment

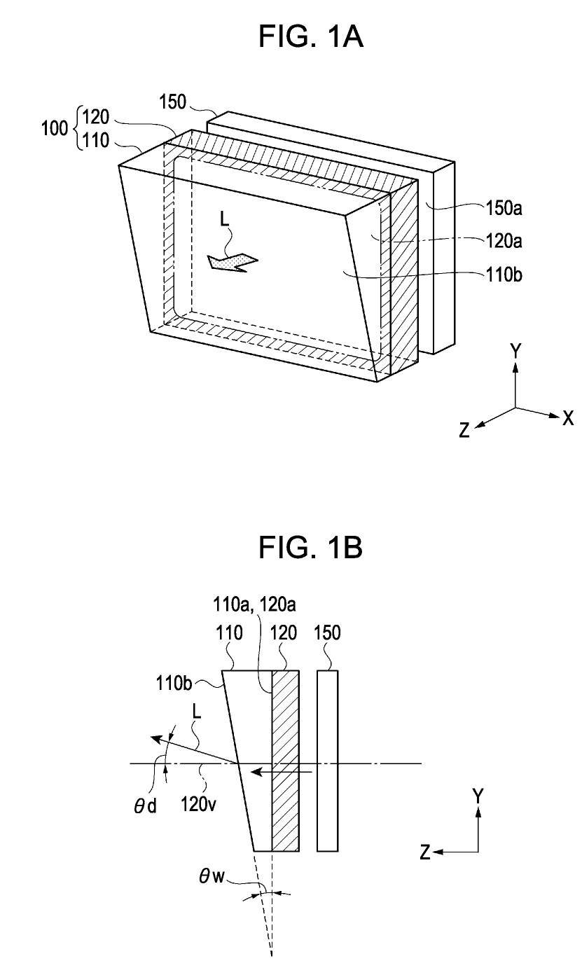

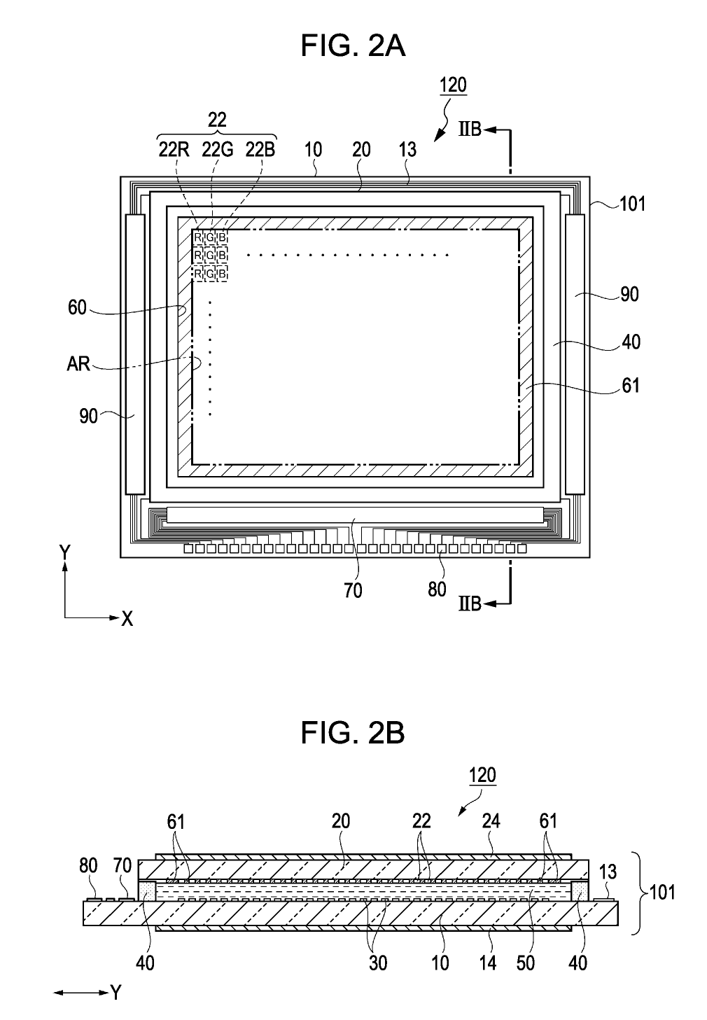

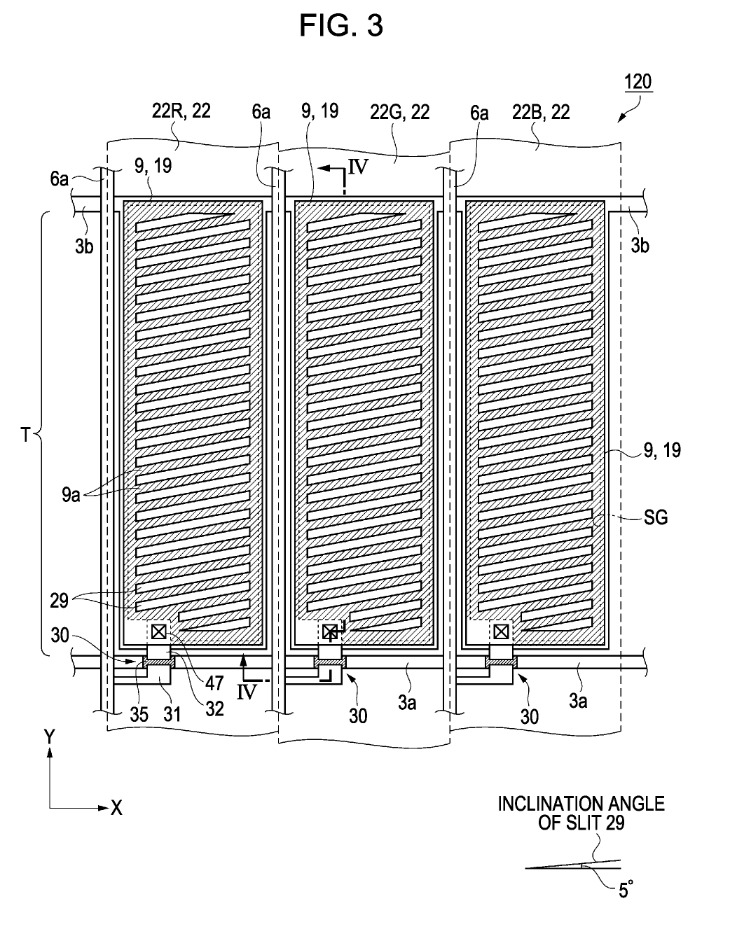

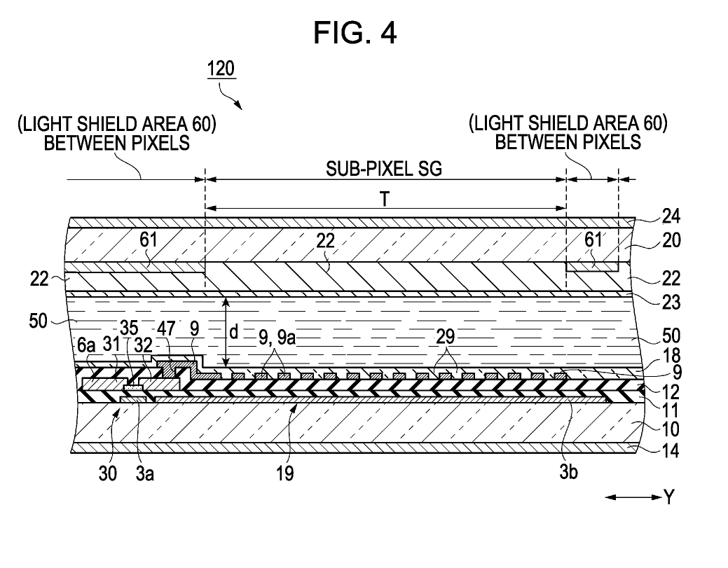

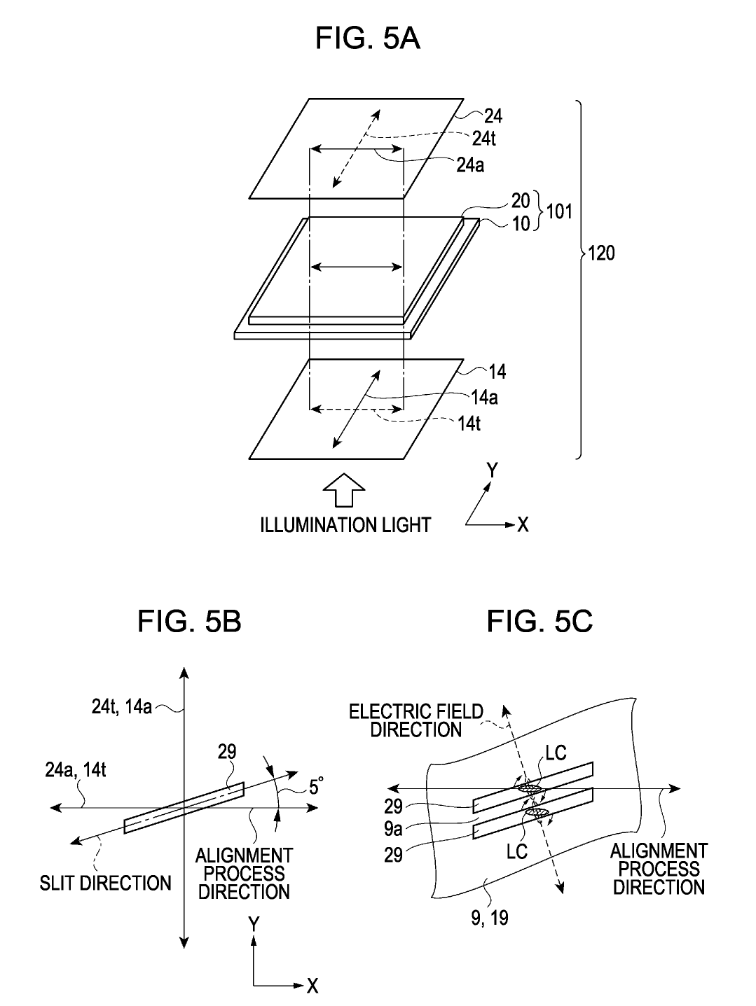

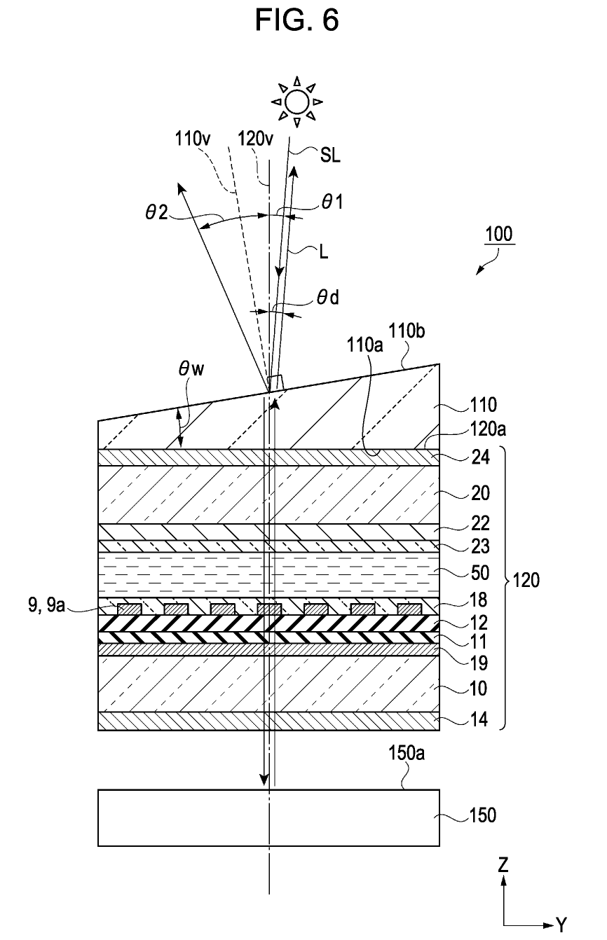

A display device according to the embodiment will be described with reference to FIG. 1A to FIG. 6. FIG. 1A is a schematic perspective view illustrating a configuration of the display device, FIG. 1B is a schematic cross-sectional view illustrating the display device, FIG. 2A is a schematic plan view illustrating a configuration of a display panel, FIG. 2B is a schematic cross-sectional view illustrating the display panel, FIG. 3 is a schematic plan view illustrating a configuration of pixels, FIG. 4 is a schematic cross-sectional view of main parts illustrating a structure of pixels, FIG. 5A is a schematic view illustrating an optical design condition in the display panel, FIG. 5B is a schematic view illustrating an optical design condition in the display panel, FIG. 5C is a schematic view illustrating an optical design condition in the display panel, and FIG. 6 is a schematic cross-sectional view illustrating an influence of sunlight in the display device.

As shown in FIG. 1A, a display device 100 of the embodiment includes a display panel 120, and a prism 110 provided on a display face 120a of the display panel 120. In this case, the display panel 120 is a light receiving type and performs displaying by illumination of a lighting device 150 provided on the opposite side (rear side) to the display face 120a. Accordingly, the display device 100 may have a configuration including the lighting device 150.

The lighting device 150 is a light source provided to obtain uniform brightness from a light emitting face 150a, for example, includes a cold cathode fluorescent lamp (CCFL) and a light emitting diode (LED), and a light guide plate, a reflection plate and a diffusion plate which leads light from the light source to the light emitting face 150a. As a lighting type, an underlying type in which the light source is provided right under the light emitting face 150a or a side type in which the light source is provided at the end portion of the light guide plate is conceivable.

The prism 110 provided on the front side of the display panel 120 has a single inclination face 110b inclined from the display face 120a at a predetermined angle. Such a prism 110 is generally called a wedge prism.

As shown in FIG. 1B, the prism 110 is provided on the display panel 120 such that a first face 110a opposed to the inclination face 110b comes into close contact with the display face 120a.

As a method of bringing the first face 110a into close contact with the display face 120a without a gap, there is a method in which they are pressed together with an intermediate material such as a transparent adhesive or cohesive agent or a gel type member. For example, a method uniformly interposing an adhesive agent therebetween is disclosed in JP-A-2009-3067.

Illumination light emitted from the lighting device 150 and perpendicularly input to the display face 120a is transmitted through the display panel 120 to be display light L based on display information, and the display light L is input to the prism 110. The prism 110 has a declination angle θd regulated by an inclination angle (or wedge angle) θw of the inclination face 110b and a refractive index n. The display light L transmitted through the prism 110 is output from the inclination face 110b in a direction inclined by the declination angle θd with respect to a normal line 120v of the display face 120a. That is, the inclination angle θd may be called an output angle θd of the display light L on the inclination face 110b.

Such a display device 100 is appropriately used for a head-up display (HUD) as an electronic device to be described later.

In this case, the following description is made by considering that the display panel 120 is rectangular, a long-side direction of the display face 120a is an X direction, a short-side direction is a Y direction, and a normal line direction of the display face 120a is a Z direction.

The prism 110 is provided on the display panel 120 such that the inclination face 110b of the prism 110 is inclined in the short-side direction (Y direction) of the display panel 120, but is not limited thereto. A method of optically disposing the prism 110 will be described later.

Next, the display panel 120 will be described. As shown in FIG. 2A and FIG. 2B, the display panel 120 is provided with an element substrate 10, and an opposite substrate 20 smaller in size than the element substrate 10 in the plan view, which are opposed to each other.

A gap between the element substrate 10 and the opposite substrate 20 bonded by a seal member 40 is filled with liquid crystal having positive dielectric anisotropy, to form a liquid crystal layer 50. That is, the liquid crystal layer 50 is sandwiched between the element substrate 10 and the opposite substrate 20.

The outside of the seal member 40 is a peripheral circuit area, where a data line driving circuit 70 and a plurality of terminals 80 for connection to external circuits are provided along one side of the element substrate 10 in the long-side direction (X direction). In addition, scanning line driving circuits 90 are provided along the two other sides in the short-side direction (Y direction) of the element substrate 10. A plurality of wires 13 connecting the two scanning line driving circuits 90 to each other are provided along the one other side of the element substrate 10.

A plurality of pixels arranged in a matrix shape are provided inside the seal member 40 in the X direction as a first direction and the Y direction as a second direction perpendicular to the X direction. One pixel is formed of three sub-pixels corresponding to 3-color filters 22R (red), 22G (green), and 22B (blue). The 3-color filters 22R, 22G, and 22B are formed on the opposite substrate 20 such that the color filters 22 of the same color are continuous in the Y direction. A plurality of TFTs (Thin Film Transistor) 30 are provided as switching elements for sub-pixels on the element substrate 10 to control the sub-pixels. That is, the display panel 120 is an active liquid crystal panel capable of color display with stripe-type color filters 22.

In the embodiment, an area of a plurality of pixels contributing to real display is a display area AR, and a light shield film 61 partitioning the sub-pixels and shielding light of the display area AR in a frame shape is provided. A light shield area 60 where the light shield film 61 is provided is a reference regulating a position of the display area AR when the display panel 120 and the prism 110 are attached to each other.

Polarization plates 14 and 24 as polarization elements are attached to the outward surfaces (surfaces opposite to the liquid crystal layer 50) of the element substrate 10 and the opposite substrate 20. The display panel 120 excluding the polarization plates 14 and 24 may be called a liquid crystal cell 101 for descriptive purposes.

As shown in FIG. 3, one pixel of the display panel 120 is formed of three sub-pixels SG corresponding to the 3-color (R, G, and B) filters 22R, 22G, and 22B. Each sub-pixel SG is provided with a rectangular pixel electrode 9 in which a plurality of slits (gap) 29 are formed in a substantially ladder shape. That is, the sub-pixel SG is rectangular.

The plurality of pixels are provided in a matrix shape such that the long-side direction of the sub-pixels SG is a column direction of the pixels.

A scanning line 3a, a common line 3b, and a plurality of data lines 6a are provided to surround the outer periphery of the pixel electrodes 9.

The TFTs 30 are formed in the vicinity of the cross portion of the scanning line 3a and the data lines 6a, and the TFTs 30 are electrically connected to the data lines 6a and the pixel electrodes 9.

Rectangular common electrodes 19 are formed at positions overlapping with the pixel electrodes 9 in the plan view. The common electrodes 19 may be provided in a solid shape throughout the sub-pixels adjacent SG connected along the common line 3b.

The pixel electrode 9 is a transparent conductive film formed of a conductive material such as ITO (Indium Tin Oxide). The pixel electrode 9 of one sub-pixel SG is provided with a plurality (24 in FIG. 3) of slits 29. The slits 29 extend in a cross direction (inclination direction in FIG. 3) of the scanning line 3a and both of the data lines 6a, and are formed to be arranged at the same interval in the Y direction along the data lines 6a. The slits 29 are formed with substantially the same width and are parallel to each other. Accordingly, the pixel electrode 9 has stripe-shaped electrode portions 9a with a plurality of lines (23 in FIG. 3). Since the slits 29 are arranged at a regular width at the same interval, the stripe-shaped electrodes portions 9a are arranged at a regular width at the same interval. All of the width of the slits 29 and the width of the stripe-shaped electrode portions 9a are about 4 μm. It is preferable that the pixel electrode 9 coming into contact with the liquid crystal layer 50 has the stripe-shaped electrode portion 9a, and the portion between the stripe-shaped electrode portions 9a is not limited to the slit 29, both ends of which are closed, and may be a slit, one end of which is opened.

In this case, an inclination angle of the slit 29 in the X direction along the scanning line 3a is 5°. Hereinafter, such a slit 29 is called a right-rising (5°) slit 29.

The common electrode 19 is a transparent conductive film formed of a conductive material such as ITO, and is formed integrally with the common line 3b extending parallel to the scanning line 3a. Accordingly, the common electrode 19 is electrically connected to the common line 3b.

From the viewpoint of transmitting electrical signals, it is preferable that the scanning line 3a, the data line 6a, and the common line 3b are formed of conductive materials with low resistance, for example, aluminum, aluminum alloy, or the like.

The TFT 30 is provided with a semiconductor layer 35 formed of an island-shaped amorphous silicon film partially formed on the scanning line 3a, a source electrode 31 branched from the data line 6a and extending on the semiconductor layer 35, and a rectangular drain electrode 32 extending from the upside of the semiconductor layer 35 to the forming area of the pixel electrode 9.

The scanning line 3a functions as a gate electrode of the TFT 30 at a position opposed to the semiconductor layer 35. The drain electrode 32 and the pixel electrode 9 are electrically connected to each other through a contact hole 47 formed at an overlapping position of both in the plan view.

In the sub-pixel SG, since an area where the pixel electrode 9 overlaps with the common electrode 19 in the plan view functions as a capacitor of the sub-pixel SG, it is not necessary to provide a special capacitor for keeping image signals in the forming area of the sub-pixel SG, and thus it is possible to obtain a high aperture ratio.

In this case, the area where the pixel electrode 9 overlaps with the common electrode 19 in the plan view is a transmission display area T.

As shown in FIG. 4, in the display panel 120, the liquid crystal layer 50 is sandwiched between the element substrate 10 having the pixel electrode 9 and the common electrode 19, and the opposite substrate 20.

The light shield film 61, the color filters 22 (22R, 22G, and 22B), and an alignment layer 23 covering the color filters 22 are formed toward the liquid crystal layer 50 on the opposite substrate 20 formed of transparent glass or the like.

The light shield film 61 is called a black matrix (BM) provided to substantially divide the color filters 22 for each sub-pixel SG (for each color) as viewed from the opposite substrate 20 side. As method of forming the same, for example, there is a method in which a thin film of metal or metal compound as a lightproof material is formed on the surface (liquid crystal layer 50 side) of the opposite substrate 20, and patterning is performed to have an opening portion corresponding to the sub-pixel SG by photolithography. As a general metal or metal compound, there is chrome (Cr) or chrome oxide. In addition, there is a method of patterning resin including a black pigment as the lightproof material by a printing method such as offsetting.

The color filters 22 may be formed, for example, in a manner that a photosensitive resin material including a coloring material of each color is applied to the opposite substrate 20 on which the light shield film 61 is formed, and it is exposed and developed by photolithography to fill the opening portion of the light shield film 61. Methods such as spin coat and slit coat may be used as the applying method. The color filters 22 may be formed by providing a partition wall portion on the light shield film 61 and using a method of applying liquid including the coloring material of each color as liquid droplets to an area partitioned by the partition wall portion. A thickness of the color filter 22 is about 1 μm to 2 μm.

Similarly, the scanning line 3a, the common electrode 19, and the common line 3b are formed on the element substrate 10 formed of transparent glass or the like. A gate insulating film 11 formed of a silicon oxide film or the like is formed to cover the scanning line 3a, the common electrode 19, and the common line 3b.

The island-shaped semiconductor layer 35, a source electrode 31, and a drain electrode 32 are formed on the gate insulating film 11 such that the source electrode 31 and the drain electrode 32 partially overlap with the semiconductor layer 35.

An interlayer insulating film 12 formed of a silicon oxide film or a resin film is formed to cover the semiconductor layer 35, the source electrode 31, and the drain electrode 32.

The pixel electrode 9 is formed on the interlayer insulating film 12, and the pixel electrode 9 is electrically connected to the drain electrode 32 through a contact hole 47 penetrating the interlayer insulating film 12 and reaching the drain electrode 32.

That is, the gate insulating film 11 and the interlayer insulating film 12 as insulating films are interposed between the common electrode 19 and the pixel electrode 9.

An alignment layer 18 formed of polyimide or the like is formed to cover the pixel electrode 9 of the element substrate 10. The alignment layer 18 on the element substrate 10 side and the alignment layer 23 on the opposite substrate 20 side coming into contact with the liquid crystal layer 50 are subjected to an alignment process such as a rubbing process, to align liquid crystal molecules in a predetermined direction. Details of the alignment process will be described in optical design conditions to be described later.

A polarization plate 24 is attached to the surface (surface opposite to the liquid crystal layer 50 side) of the opposite substrate 20, and a polarization plate 14 is attached to the surface (surface opposite to the liquid crystal layer 50 side) of the element substrate 10.

The display panel 120 with such a structure controls the alignment direction of the liquid crystal molecules of the liquid crystal layer 50 by an electric field generated between the pixel electrode 9 having the stripe-shaped electrode portion 9a and the common electrode 19 to perform displaying, and is called an FFS (Fringe Field Switching) method.

Next, the optical design conditions of the display panel 120 will be described with reference to FIG. 5A to FIG. 5C.

As shown in FIG. 5A, the initial alignment of the liquid crystal cell 101 in the display panel 120 is homogeneous alignment taken along a line direction of pixels, that is, the X direction. More specifically, the rubbing direction in the alignment layer 18 of the element substrate 10 and the rubbing direction in the alignment layer 23 of the opposite substrate 20 are taken along the X direction, but are reversed by 180°.

Optical disposition of the pair of polarization plates 14 and 24 is in a cross-Nicol state (transmission axes or absorption axes are perpendicular to each other) with the liquid crystal cell 101 interposed therebetween. Specifically, an absorption axis 14a of the polarization plate 14 provided on the side to which light is input from the lighting device 150 is perpendicular to the initial alignment direction of the liquid crystal cell 101. That is, a transmission axis 14t is the same direction as the initial alignment direction. On the contrary, an absorption axis 24a of the polarization plate 24 provided on the side from which light is output is the same direction as the initial alignment direction of the liquid crystal cell 101. The transmission axis 24t is perpendicular to the initial alignment direction.

That is, the illumination light is transmitted through the polarization plate 14 and converted into straight polarized light, and the straight polarized light is transmitted through the liquid crystal cell 101. However, the light is absorbed by the polarization plate 24. Accordingly, the non-driving state, that is, the initial alignment state is black display.

As shown in FIG. 5B, the slit 29 of the pixel electrode 9 is inclined at a right-rising from the alignment process direction by 5°. Accordingly, as shown in FIG. 5C, when driving voltage is applied between the pixel electrode 9 having the stripe-shaped electrode portion 9a and the common electrode 19 opposed thereto, electric field is generated in a direction perpendicular to the extending direction of the stripe-shaped electrode portion 9a (or slit 29) in the plan view.

The liquid crystal molecules LC having positive dielectric anisotropy is aligned such that long axes thereof are in the electric field direction, and thus the liquid crystal molecules LC are twisted clockwise in the vicinity of the stripe-shaped electrode portion 9a. Accordingly, optical activation is generated in the liquid crystal layer 50. The illumination light converted into the straight polarized light by the polarization plate 14 is rotated and transmitted through the polarization plate 24 while it is transmitted through the liquid crystal cell 101. That is, at the driving time, colors colored by the color filters 22 are observed, a white color is displayed when all the sub-pixels SG constituting one pixel are in the driving state. Such a display mode is called a normally black mode.

The angle formed between the alignment process direction and the stripe-shaped electrode portion 9a (or slit 29) is not limited to 5°. When the electric field is generated, the liquid crystal molecules LC stabilized in a regular direction are set to a twisted angle.

Next, optical disposition of the prism 110 in the display device 100 will be described with reference to FIG. 6.

As shown in FIG. 6, when the display panel 120 is driven, the illumination light output from the light emitting face 150a of the lighting device 150 is transmitted through the display panel 120 as described above and input to the prism 110. The prism 110 has a polarization angle θd regulated by an inclination angle θw of the inclination face 110b and an refractive index n, and the display light L input to the prism 110 is output in a direction inclined from the normal line 120v of the display face 120a by an output angle θd.

When such a display device 100 is used for the head-up display or the like to be described later, the display device 100 is set such that sunlight SL is input in a direction opposite to the output direction of the display light L. A part of the sunlight SL input to the prism 110 is reflected from the inclination face 110b in a direction symmetrical about the normal line 110v as an axis.

The sunlight SL transmitted through the prism 110 may be reflected on several interfaces of the display panel 120, such as an interface between the polarization plate 24 and the opposite substrate 20. However, a refractive index difference in the interface is small, the sunlight SL is absorbed by the polarization plate 24 or the color filters 22, and thus intensity of the reflection light of the sunlight SL gets lower. The sunlight SL transmitted through the polarization plate 14 and reaching the lighting device 150 is dispersed and mixed with the illumination light again since a gap is formed between the polarization plate 14 and the light emitting face 150a. Accordingly, it has no influence on displaying.

An incident angle θ1 of the sunlight SL input to the inclination face 110b of the prism 110 is not necessarily regular. From such a viewpoint, it is necessary to miss the sunlight SL such that the sunlight SL reflected from the inclination face 110b does not come into contact with a viewer's eyes. In other words, the inclination angle θw of the inclination face 110b of the prism 110 is set such that the display light L reaches a range other than a range which the reflection light of the sunlight SL reaches.

An angle formed between the normal line 110v of the inclination face 110b and the normal line 120v of the display face 120a is the same as the inclination angle θw of the inclination face 110b. For example, when the incident angle θ1 of the sunlight SL to the normal line 120v is the same the output angle θd of the display light L, the reflection angle θ2 of the sunlight SL is a value obtained by subtracting the output angle θd from double of sum of the inclination angle θw and the output angle θd.

The relation of the incident angle θ1 and the reflection angle θ2 of the sunlight SL, the inclination angle θw of the prism 110, and the output angle (polarization angle) θd can be calculated by Formula (1) and Formula (2) based on Snell's law.

n×sin θw=sin(θw+θd) (1)

θ1+θ2=θt=arcsin(n×sin θw)×2 (2)

where n is a refractive index of the prism 110.

The sum θt of the incident angle θ1 and the reflection angle θ2 of the sunlight SL is not necessarily regular, but is set in the range of 20° to 50° when the display device 100 is used for the head-up display or the like to be described later.

For example, the prism 110 is formed of glass or the like mainly including SiO₂, and a refractive index n thereof is 1.45. When the sum θt of the incident angle θ1 and the reflection angle θ2 of the sunlight SL is 20°, the inclination angle θw is about 7°. In addition, the output angle θd is about 3°. Accordingly, in a visual angle range of ±10° (the sum of the inclination angle θw and the output angle θd) to the normal line 110v of the inclination face 110b, the image displayed on the display panel 120 is not affected by the sunlight SL. In other words, when the output angle θd of the display light L is equal to or larger than a small angle of the incident angle θ1 and the reflection angle θ2 of the sunlight SL input to the inclination face 110b, the reflection light of the sunlight SL does not reach the viewer's eyes. That is, when the sum θt is 20°, the inclination angle θw is made into 7° or more.

Similarly, when the sum θt is 50°, the inclination angle θw is about 17°. In this case, the output angle θd is about 8°. In other words, in a visual angle range of ±25° (the sum of the inclination angle θw and the output angle θd) to the normal line 110v of the inclination face 110b, the image displayed on the display panel 120 is not affected by the sunlight SL.

When the inclination angle θw of the inclination face 110b in the prism 110 gets larger, color separation of the display light L transmitted through the prism 110 occurs by the influence of wavelength dispersion. Accordingly, it is preferable that the inclination angle θw is equal to or less than 30° at which it is hard to be affected by the wavelength dispersion.

It is obvious that the prism 110 is preferably formed of a transparent material through which a visible layer passes.

For example, the prism 110 is formed of a resin material such as polycarbonate, and a refractive index n thereof is 1.59. When the sum θt is 20°, the inclination angle θw is about 6.5°. In addition, the output angle θd is about 3.5°.

Similarly, when the sum θt is 50°, the inclination angle θw is about 15.5°. In this case, the output angle θd is about 9.5°.

The resin material may be episulfide-based resin in addition to the polycarbonate, a refractive index n thereof is about 1.70. When the sum θt is 20°, the inclination angle θw is about 6°. In addition, the output angle θd is about 4°.

Similarly, when the sum θt is 50°, the inclination angle θw is about 14.5°. In this case, the output angle θd is about 10°.

The prism 110 may have a configuration in which it is filled with liquid such as water, and a refractive index n thereof is 1.33. When the sum θt is 20°, the inclination angle θw is about 7.5°. In addition, the output angle θd is about 2.5°.

Similarly, when the sum θt is 50°, the inclination angle θw is about 18.5°. In this case, the output angle θd is about 6.5°.

When the refractive n index of a proper material of the prism 110 is assumed as described above, the inclination angle θw of the inclination face 110b to the display face 120a is equal to or more than about 6° and equal to or less than 18.5°.

When the sum θt of the incident angle θ1 and the reflection angle θ2 of the sunlight SL is 30° that is an intermediate value of 20° to 50° and when the influence of the wavelength dispersion of the prism 110 and the refractive index n (about 1.5) of an easily available prism material (e.g., BK7) are considered, it is preferable that the inclination angle (wedge angle) θw of the prism 110 is about 10°.

Since the sunlight SL may be input to the inclination face 110b at various angles, as shown in FIG. 6, the incident direction of the real sunlight SL is projected to a cross section taken by cutting the prism 110 in the Y direction and the incident angle θ1 is prescribed.

### Comparative Example

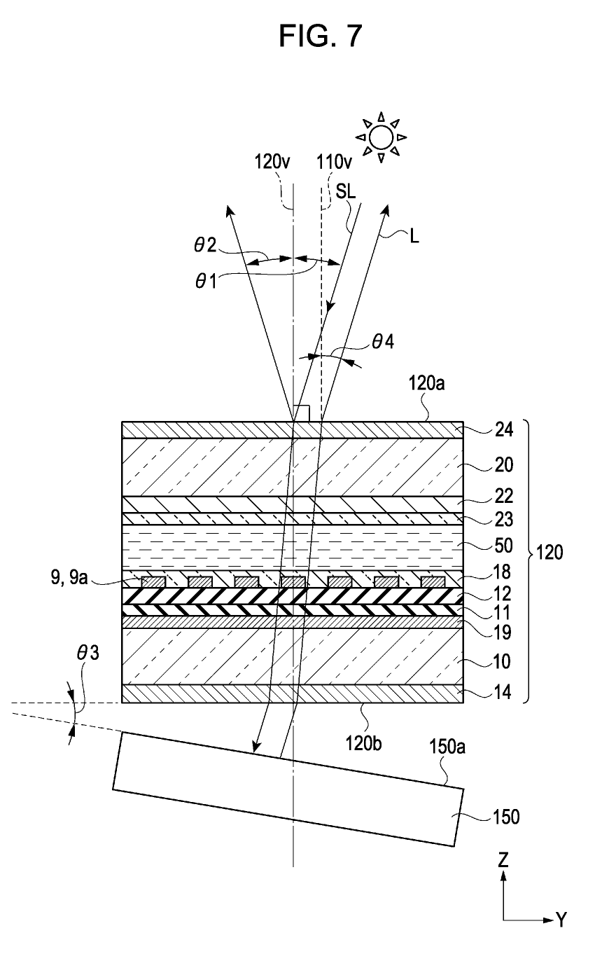

Next, Comparative Example will be described with reference to FIG. 7. FIG. 7 is a schematic cross-sectional view illustrating optical disposition of a display panel and a lighting device according to Comparative Example.

As shown in FIG. 7, in the display panel 120 and the lighting device 150 according to Comparative Example, the light emitting face 150a is inclined and the lighting device 150 is disposed with respect to the display panel 120 such that the illumination light is input to the surface 120b opposite to the display face 120a in the inclination direction.

When an inclination angle of the light emitting face 150a to the surface 120b is θ3, an output angle θ4 of the display light L to the normal line 120v of the display face 120a is substantially the same as the inclination angle θ3.

The sunlight SL input to the display face 120a at the incident angle θ1 from the output direction of the display light L to the normal line 120v of the display face 120a is reflected at the reflection angle θ2. In this case, the incident angle θ1 is equivalent to the reflection angle θ2.

For example, when the inclination angle θ3 of the lighting device 150 is 15°, all of the output angle θ4 of the display light L and the incident angle θ1 of the sunlight SL are 15°. Accordingly, in a visual angle range of ±15° to the normal line 120v, it is hard to be affected by the reflection of the sunlight SL. That is, the same operation and effect as the display device 100 provided with the prism 110 are obtained.

However, when the lighting device 150 is disposed to be inclined from the display panel 120 as described in Comparative Example, there is a problem that the desired optical characteristics cannot obtained in a predetermined visual angle range.

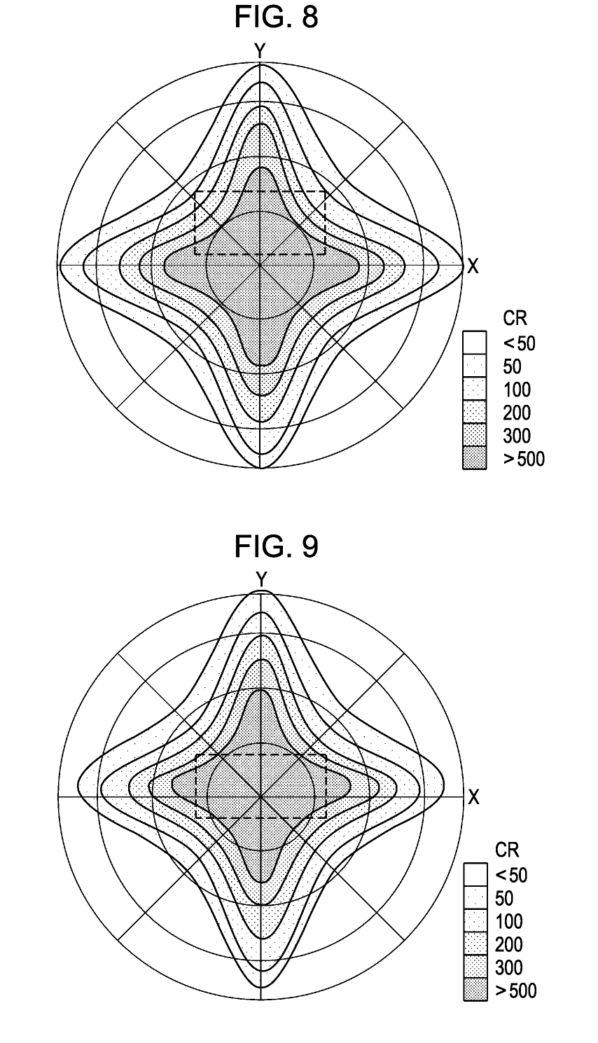

FIG. 8 is a graph illustrating contrast characteristics in the display panel. Specifically, diffused light is input to the surface 120b of the display panel 120, an angle to the normal line 120v is changed, and brightness of the display light L is measured, thereby obtaining a contour contrast curve. The center of FIG. 8 denotes the normal line direction, axes passing through the center denote orientation angles, and concentric circles denote polar angles from the normal line 120v, which represent 20°, 40°, 60°, and 80° in order from the inside.

As shown in FIG. 8, in the display panel 120, the highest contrast (CR) is obtained as viewed in the normal line direction. It is a good balanced state capable of high contrast in the left-right direction (X direction) and the up-down direction (Y direction). However, when the lighting device 150 is disposed to be inclined from the display panel 120 at about 15° as described in Comparative Example, the output direction of the display light L is inclined at 15° in the Y direction. Accordingly, contrast distribution in real displaying deviates to be a rectangular range surrounded by the broken line. That is, the contrast decreases in the upside corner of an image.

FIG. 9 is a graph illustrating contrast characteristics in the display device according to the embodiment. Specifically, it is a contour contrast curve when the inclination angle θw of the inclination face 110b of the prism 110 is 10°. As shown in FIG. 9, in the case of the display device 100 of the embodiment, the illumination light output from the lighting device 150 is input in the direction perpendicular to the display face 120a of the display panel 120. The display light L output from the display face 120a is input to the prism 110, and then is output from the inclination face 110b in the direction inclined at the output angle θd from the normal line 120v.

In this case, when the refractive index n of the prism 110 is 1.5, the output angle θd is about 5°. That is, the contour contrast curve deviates in the up-down direction (Y direction) by 5°, and thus the optimal visual angle range also deviates in the up-down direction (Y direction) by 5°. Accordingly, contrast distribution in real displaying is a rectangular range surrounded by the broken line, the contrast in the corner portion of an image does not decrease as compared with Comparative Example shown in FIG. 8, and it is possible to obtain overall high contrast.

In Comparative Example, the illumination light is transmitted obliquely to the thickness direction (Z direction) through the display panel 120, color shift occurs on an image face. However, in the display device 100, it is possible to obtain the effect of reducing such color shift.

According to the first embodiment described above, it is possible to obtain the following advantages.

(1) The display device 100 has the prism 110 disposed on the display face 120a of the display panel 120, the inclination angle θw of the inclination face 110b of the prism 110 to the display face 120a is equal to or more than 6° and equal to or less than 18.5°. Accordingly, when the sum θt of the incident angle θ1 and the reflection angle θ2 of the sunlight SL to the inclination face 110b is set in the range of 20° to 50°, the reflection light of the sunlight SL can be missed in a direction in which the display light L reaches the viewer. Therefore, it is possible to suppress the influence which the sunlight SL has on displaying.

(2) Since the prism 110 is disposed in close contact with the display face 120a of the display panel 120, it is suppressed that the sunlight SL is transmitted through the prism 110 and is reflected from the surface of the polarization plate 24 of the display panel 120.

(3) Since the display device 100 is provided with the prism 110 having the inclination face 110b inclined at a predetermined angle on the display face 120a of the display panel 120, it is possible to avoid that the visual angle direction in which the optimal contrast of the display panel 120 can be obtained deviates from the output direction of the display light L as compared with Comparative Example.

(4) In JP-A-2007-65011, when the sunlight SL input to the display face of the liquid crystal cell, for example, at the incident angle θ1 is missed at an angle corresponding to the sum θt of the incident angle θ1 and the reflection angle θ2 from the output direction of the display light L, it is necessary to incline the transreflective member from the display face at an angle of a half of the sum θt. On the contrary, in the display device 100, since the prism 110 having the inclination face 110b with the inclination angle θw smaller than the half of the sum θt is disposed on the display face 120a, it is possible to provide the smaller display device 100.

### Second Embodiment

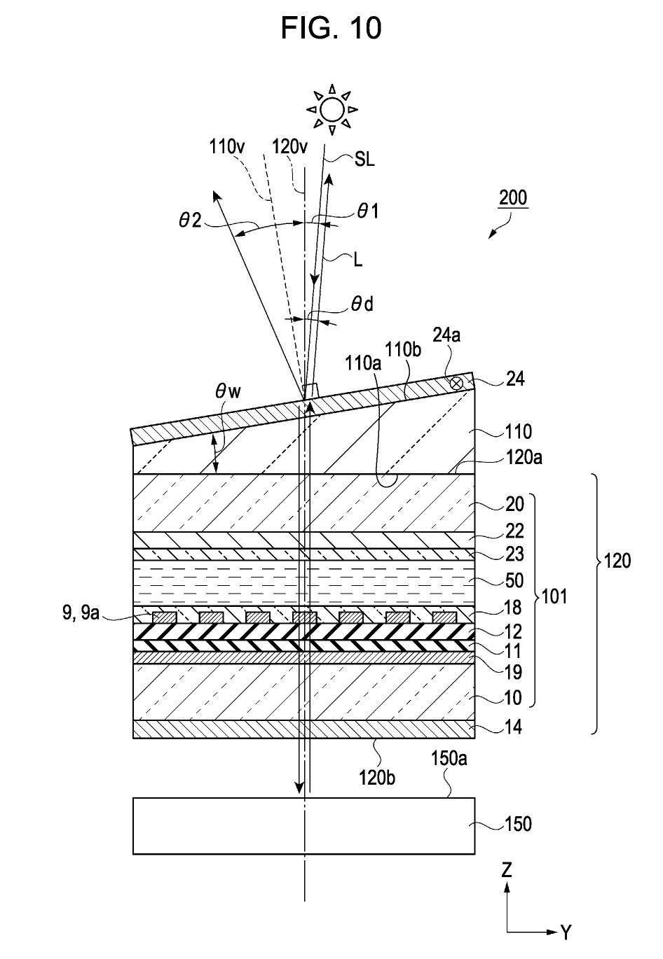

Next, a display device according to a second embodiment will be described with reference to FIG. 10. FIG. 10 is a schematic cross-sectional view illustrating a configuration of the display device according to the second embodiment. The same reference numeral and sign are given to the same configuration as the display device 100 of the first embodiment, and detailed description thereof is not repeated.

As shown in FIG. 10, basically, the display device 200 of the second embodiment has the same configuration as the display device 100 of the first embodiment, but there are differences in the following points.

The surface of the opposite substrate 20 opposed to the liquid crystal layer 50 is the display face 120a, and the prism 110 is disposed to come into close contact with the display face 120a. The polarization plate 24 as a polarization element on the side to which the sunlight SL is input is attached to the inclination face 110b of the prism 110.

The polarization plate 24 is attached to the inclination face 110b such that the direction of the absorption axis 24a is the same as the initial alignment direction of the liquid crystal molecules in the liquid crystal layer 50. In other words, the inclination direction (Y direction) of the inclination face 110b of the prism 110 crosses (perpendicularly) to the direction of the absorption axis 24a of the polarization plate 24.

According to the display device 200 of the embodiment, the relation of the sum θt of the incident angle θ1 and the reflection angle θ2 of the sunlight SL to the inclination face 110b based on Snell's law, the inclination angle θw of the prism 110, and the polarization angle θd is kept similarly to the display device 100 of the first embodiment, and the same operation and effect as the first embodiment is obtained.

In addition, since the polarization plate 24 easily heated by the sunlight SL is attached to the inclination face 110b of the prism 110 separated from the liquid crystal cell 101, it is possible to prevent the optical characteristics of the display panel 120 from being changed by the influence of the heat of the sunlight SL.

Since the absorption axis 24a of the polarization plate 24 is the same direction of the initial alignment direction of the liquid crystal molecules, it is possible to prevent the visual angle characteristics from being changed even when the polarization plate 24 is attached to the inclination face 110b.

### Third Embodiment

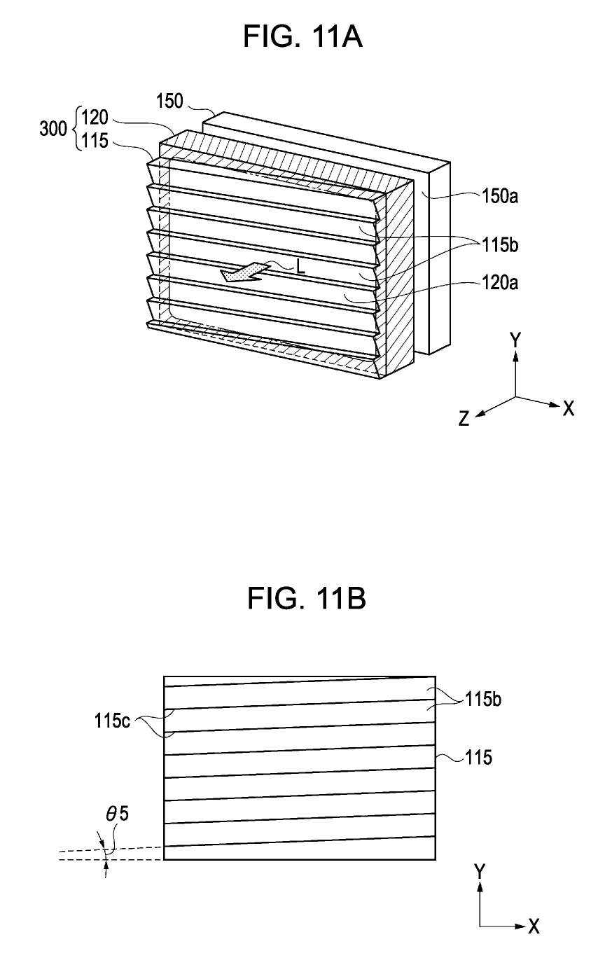

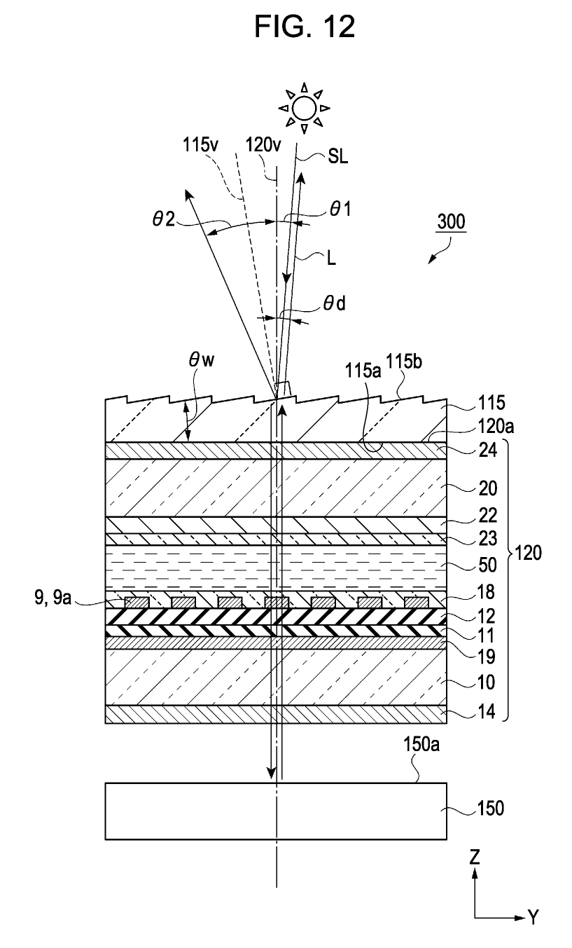

Next, a display device according to a third embodiment will be described with reference to FIG. 11A, FIG. 11B, and FIG. 12. FIG. 11A is a schematic perspective view illustrating a configuration of the display device of the third embodiment, FIG. 11B is a front view illustrating the display device of the third embodiment, and FIG. 12 is a schematic cross-sectional view illustrating a configuration of the display device of the third embodiment. The same reference numeral and sign are given to the same configuration as the display device 100 of the first embodiment, and detailed description thereof is not repeated.

As shown in FIG. 11A, the display device 300 has a display panel 120 and a prism 115 provided on the display face 120a of the display panel 120. The display panel 120 is a light receiving type, and is illuminated by the lighting device 150 provided on the side (rear side) opposite to the display face 120a and performs displaying. Accordingly, the display device 300 may include the lighting device 150.

The prism 115 provided in front of the display panel 120 has a plurality of inclination faces 115b inclined in the Y direction (direction crossing to the initial alignment direction of the liquid crystal molecules) at a predetermined angle from the display face 120a. Such a prism 115 is processed in a sheet shape, and is generally called a prism sheet. Hereinafter, the prism 115 is referred to as a prism sheet 115.

As shown in FIG. 11B, when viewing the display device 300 from the side on which the display light L is output, a long side crosses to a corner 115c of the inclination face 115b at a predetermined angle θ5. In other words, the prism sheet 115 is disposed on the display panel 120 such that the corner 115c representing the extending direction of the inclination face 115b is inclined to the X direction, that is, the line direction of pixels.

The method of inclining the corner 115c is not limited thereto, and may cross the corner 115c to the line direction (X direction) or the column direction (Y direction) of the pixels. Accordingly, it is possible to prevent an interference pattern from occurring, by avoiding optical interference with the pixels arranged in the X direction and Y direction.

As shown in FIG. 12, the prism sheet 115 is provided such that a first face 115a opposed to the inclination face 115b comes into close contact with the display face 120a of the display panel 120 that is an FFS transmission liquid crystal panel.

An inclination angle θw formed between the inclination face 115b inclined from the Y direction and the display face 120a is set equal to or more than 6° and equal to or less than 18.5° in the same manner as the prism 110 in the display device 100 of the first embodiment, when the sum θt of the incident angle θ1 and the reflection angle θ2 of the sunlight SL on the inclination face 115b is equal to or more than 20° and equal to or less than 50°.

As a material of the prism sheet 115, a resin material such as polycarbonate is appropriately used from the viewpoint of workability, and a refractive index n thereof is about 1.59. In FIG. 12, the sum θt of the incident angle θ1 and the reflection angle θ2 of the sunlight SL is about 32°, the inclination angle θw is about 10°, and the output angle θd is about 6°.

That is, the illumination light substantially perpendicularly input from the light emitting face 150a of the lighting device 150 to the surface 120b of the display panel 120 is transmitted through the display panel 120 to be converted into the display light L representing display information, and is output from the inclination face 115b in a direction inclined at about 6° from the normal line 120v of the display face 120a.

For example, a part of the sunlight SL input from the output direction of the display light L is reflected from the inclination face 115b in a direction symmetrical to the normal line 115v, and is missed from a viewer's visible direction. The sunlight SL transmitted through the prism sheet 115 may be reflected on several interfaces of the display panel 120, such as an interface between the polarization plate 24 and the opposite substrate 20. However, a refractive index difference is small, the sunlight SL is absorbed by the polarization plate 24 or the color filters 22, and thus intensity of the reflection light of the sunlight SL gets lower. Since the sunlight SL transmitted through the polarization plate 14 and reaching the lighting device 150 is dispersed and mixed with the illumination light again, it has no influence on displaying.

According to display device 300 of the third embodiment, the relation of the sum θt of the incident angle θ1 and the reflection angle θ2 of the sunlight SL to the inclination face 115b based on Snell's law, the inclination angle θw of the prism sheet 115, and the polarization angle θd is kept similarly to the display device 100 of the first embodiment, and the same operation and effect as the first embodiment is obtained.

In addition, since the prism sheet 115 having the plurality of fine inclination faces 115b is attached to the display face 120a of the display panel 120, the thickness thereof can be made smaller to reduce the size as compared with the display device 100 provided with the prism 110 having the single inclination face 110b.

### Fourth Embodiment

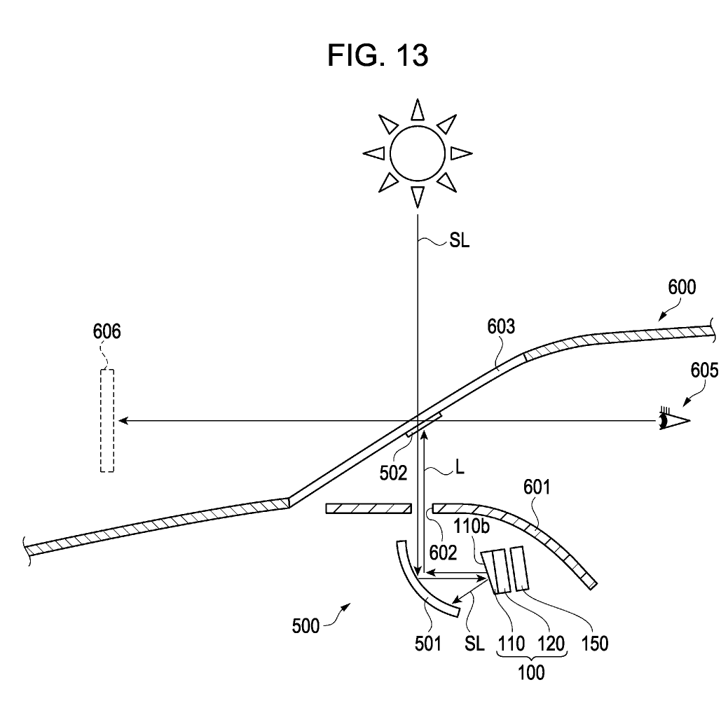

Next, a projection imaging apparatus as the electronic apparatus of the embodiment will be described by way of example. FIG. 13 is a schematic view illustrating a configuration of a head-up display as the projection imaging apparatus.

As shown in FIG. 13, the head-up display 500 as the projection imaging apparatus of the invention is provided, for example, in a vehicle 600 that is a car, and is provided with the display device 100 of the first embodiment, the lighting device 150, a concave mirror 501 as a reflection optical system which projects the display light L (image light) output from the display device 100 onto a front window 603, and a front window shield 502 which reflects the display light L projected onto the front window 603 to a rider 605.

The concave mirror 501, the display device 100, and the lighting device 150 are accommodated in a dashboard 601 such that the inclination face 110b of the prism 110 is opposed to a mirror surface of the concave mirror 501. The display device 100 and the lighting device 150 are inclined at an angle corresponding to the polarization angle θd of the prism 110 such that the display light L output from the inclination face 110b is input to the concave mirror 501 in a substantially horizontal direction in FIG. 13.

The dashboard 601 is provided with an opening portion 602 for transmitting the display light L to the downside of the front window 603.

The display light L output from the display device 100 is reflected by the concave mirror 501, is transmitted through the opening portion 602, and is projected onto the front window shield 502. The projected display light L, that is, an image is visible as a virtual image by the rider 605 in the vehicle 600. The projected image may be information such as velocity meter, the amount of remaining fuel, and various warnings, and the rider 605 can confirm such information without greatly turning away the driver's eyes during the driving.

The front window shield 502 is formed of, for example, a sheet-shaped film such as a semitransparent mirror, but the inner face of the front window 603 may be subjected to a surface treatment to reflect a part of the display light L.

According to the head-up display 500, the display device 100 is provided with the prism 110 having the inclination face 110b on the incident side of the sunlight SL. Accordingly, the sunlight SL input over the front window 603, is transmitted through the opening portion 602, is reflected by the concave mirror 501, and is input to the display device 100, and a part of the sunlight SL is reflected in a direction different from the incident direction to the inclination face 110b of the prism 110. That is, the reflection light of the sunlight SL on the inclination face 110b is missed in a direction different from the output direction of the display light L. The sunlight SL transmitted through the prism 110 is absorbed in the display panel 120, or the sunlight SL is transmitted through the display panel 120, is diffused, and is mixed with the illumination light output from the lighting device 150. That is, it is hard for the projected image to be affected by the reflection of the sunlight SL, the head-up display 500 is realized, by which the optimal contrast characteristics can be obtained in a predetermined visual angle range.

Of course, the display device 200 of the second embodiment or the display device 300 of the third embodiment may be employed instead of the display device 100.

In the embodiment, the display device 100 is disposed with respect to the concave mirror 501 such that the sunlight SL reflected by the inclination face 110b of the prism 110 is missed downward in FIG. 13, but is not limited thereto. Since the reflection light of the sunlight SL on the inclination face 110b can be missed from the output direction of the display light L, the display device 100 and the lighting device 150 may be turned by 90° about the output direction of the display light L in FIG. 13. Of course, the display direction of the image on the display panel 120 is also turned according to the turning.

In addition to the embodiments, various modified examples are conceivable. Hereinafter, modified examples will be described.

### Modified Example 1

The configuration of pixels of the display panel 120 and the optical design are not limited thereto. For example, the inclination angle of the stripe-shaped electrode portion 9a (or slit 29) of the pixel electrode 9 in FIG. 3 may be right-rising 0°, that is, horizontal. In that case, the alignment process direction is made into right-falling 5°. Even in such a configuration, the liquid crystal molecules LC are aligned in the electric field direction and are twisted clockwise. The direction of the absorption axis 24a of the polarization plate 24 is similarly made into right-falling 5°.

Accordingly, in the second embodiment, in case of attaching the polarization plate 24 to the inclination face 110b of the prism 110, when the polarization plate 24 is disposed such that the absorption axis 24a is the same as the alignment process direction, the absorption axis 24a is not perpendicular to the inclination direction (Y direction) of the inclination face 110b. However, according to an optical simulation result, in fluctuation of the angle of attaching the polarization plate 24 of about ±10° about the inclination direction, there is no influence on the visual angle characteristics of the display panel 120.

### Modified Example 2

The disposition of the prism 110 or the prism sheet 115 with respect to the display panel 120 is not limited to the direct contact to the display face 120a. For example, the display panel 120 and the prism 110 or the prism sheet 115 may be optically attached to each other through a transparent material having an intermediate refractive index between the refractive index of the material (polarization element or opposite substrate 20) constituting the display face 120a and the refractive index n of the prism 110 or the prism sheet 115.

With such a configuration, even when there is a difference between the refractive index of the material and the refractive index n of the prism 110 or the prism sheet 115, it is possible to suppress interface reflection by reducing the difference in refractive index on the interface therebetween.

### Modified Example 3

The display panel 120 is not limited to the FFS transmission liquid crystal panel. For example, even when an IPS (In Plane Switching) transmission liquid crystal panel or a VA (Vertical Alignment) transmission liquid crystal panel is used, the same operation and effect can be obtained.

In case of the VA type, the direction of the absorption axis 24a of the polarization plate 24 with respect to the inclination face 110b of the prism 110 is the same as the second embodiment. For example, an alignment control portion such as a slit or a protrusion is provided on at least one side of a pair of electrodes opposed to each other with the liquid crystal layer interposed therebetween such that the liquid crystal molecules LC are inclined in a direction forming 45° about the absorption axis 24a of the polarization plate 24 at the driving time.

### Modified Example 4

The display panel 120 is not limited to the light receiving type liquid crystal panel. For example, in an organic electro luminescent panel, a plasma panel, an FED (Field Emission Display), an SED (Surface conduction Electron emitter Display), which have a light emitting element and is a self light emitting type, the same operation and effect can be obtained. Accordingly, when the display panel 120 is the self light emitting type, the lighting device 150 is unnecessary.

Since the self light emitting organic electro luminescent panel has so-called visual angle characteristics that the light emitting characteristics are changed according to a viewing direction, it is effective to dispose the prism 110 in close contact with the display face 120a, to obtain the optimal brightness and emission colors.

Also in the self light emitting display panel, there is a case where the polarization element is disposed on the incident side of the sunlight SL, the sunlight SL is absorbed, or the reflection of the sunlight SL is made to be weakened. Accordingly, it is effective to dispose the polarization element on the inclination face 110b of the prism 110 as described in the second embodiment.

### Modified Example 5

The electronic apparatus to which the display devices 100, 200, and 300 are applied is not limited to the head-up display 500 that is the projection imaging device. For example, it can be appropriately used for a teleprompter allowing a lecturer to read a document without turning away the lecturer's eyes in a television studio, a lecture meeting, or the like under strong lighting, and a projector projecting advertisement onto a show window or the like, which may be exposed to strong light.

What is claimed is:

1. A display device comprising:
a display panel; and
a prism that is installed on a display face of the display panel and has an inclination face inclined from the display face,
wherein an inclination angle of the inclination face of the prism with respect to the display face is set such that an output angle of display light output from the display face and transmitted through the prism is equal to or more than a small angle of an incident angle and a reflection angle of sunlight with respect to the inclination face based on a normal line of the display face.

2. The display device according to claim 1, wherein the inclination angle of the inclination face is equal to or less than 30°.

3. The display device according to claim 1, wherein when a sum of the incident angle and the reflection angle of the sunlight with respect to the inclination angle based on the normal line of the display face is equal to or more than 20° and equal to or less than 50°, the inclination angle of the inclination face with respect to the display face is equal to or more than 6° and equal to or less than 18.5°.

4. The display device according to claim 1, wherein the prism is provided in close contact with the display face of the display panel.

5. The display device according to claim 1, wherein the prism is a prism sheet having a plurality of inclination faces inclined and arranged in the same direction.

6. The display device according to claim 5, wherein the display panel has a plurality of pixels arranged in a first direction and a second direction intersecting the first direction, and the prism is provided on the display panel such that an extending direction of the plurality of inclination faces intersects the first direction and the second direction.

7. The display device according to claim 1, wherein the display panel has at least a polarization element on the incident side of the sunlight, and the polarization element is provided on the inclination face of the prism.

8. The display device according to claim 7, wherein the display panel is a liquid crystal panel, initial alignment of liquid crystal molecules in the liquid crystal panel is substantially parallel to the display face, the prism is provided on the display face such that the inclination direction of the inclination face and the initial alignment direction of the liquid crystal molecules intersect with each other based on the normal line of the display face, and the polarization element is provided on the inclination face such that an absorption axis is substantially the same as the initial alignment direction.

9. An electronic apparatus comprising:
a display device that includes:
a display panel; and
a prism that is installed on a display face of the display panel and has an inclination face inclined from the display face,
wherein an inclination angle of the inclination face of the prism with respect to the display face is set such that an output angle of display light output from the display face and transmitted through the prism is equal to or more than a small angle of an incident angle and a reflection angle of sunlight with respect to the inclination face based on a normal line of the display face.

10. The electronic apparatus according to claim 9, wherein the inclination angle of the inclination face is equal to or less than 30°.

11. The electronic apparatus according to claim 9, wherein when a sum of the incident angle and the reflection angle of the sunlight with respect to the inclination angle based on the normal line of the display face is equal to or more than 20° and equal to or less than 50°, the inclination angle of the inclination face with respect to the display face is equal to or more than 6° and equal to or less than 18.5°.

12. The electronic apparatus according to claim 9, wherein the prism is provided in close contact with the display face of the display panel.

13. The electronic apparatus according to claim 9, wherein the prism is a prism sheet having a plurality of inclination faces inclined and arranged in the same direction.

14. The electronic apparatus according to claim 13, wherein the display panel has a plurality of pixels arranged in a first direction and a second direction intersecting the first direction, and the prism is provided on the display panel such that an extending direction of the plurality of inclination faces intersects the first direction and the second direction.

15. The electronic apparatus according to claim 9, wherein the display panel has at least a polarization element on the incident side of the sunlight, and the polarization element is provided on the inclination face of the prism.

16. The electronic apparatus according to claim 15, wherein the display panel is a liquid crystal panel, initial alignment of liquid crystal molecules in the liquid crystal panel is substantially parallel to the display face, the prism is provided on the display face such that the inclination direction of the inclination face and the initial alignment direction of the liquid crystal molecules intersect with each other based on the normal line of the display face, and the polarization element is provided on the inclination face such that an absorption axis is substantially the same as the initial alignment direction.

17. A projection imaging apparatus comprising:
a display device that includes:
a display panel; and
a prism that is installed on a display face of the display panel and has an inclination face inclined from the display face,
wherein an inclination angle of the inclination face of the prism with respect to the display face is set such that an output angle of display light output from the display face and transmitted through the prism is equal to or more than a small angle of an incident angle and a reflection angle of sunlight with respect to the inclination face based on a normal line of the display face.

18. The projection imaging apparatus according to claim 17, wherein the inclination angle of the inclination face is equal to or less than 30°.

19. The projection imaging apparatus according to claim 17, wherein when a sum of the incident angle and the reflection angle of the sunlight with respect to the inclination angle based on the normal line of the display face is equal to or more than 20° and equal to or less than 50°, the inclination angle of the inclination face with respect to the display face is equal to or more than 6° and equal to or less than 18.5°.

20. The projection imaging apparatus according to claim 17, wherein the prism is provided in close contact with the display face of the display panel.

21. The projection imaging apparatus according to claim 17, wherein the prism is a prism sheet having a plurality of inclination faces inclined and arranged in the same direction.

22. The projection imaging apparatus according to claim 21, wherein the display panel has a plurality of pixels arranged in a first direction and a second direction intersecting the first direction, and the prism is provided on the display panel such that an extending direction of the plurality of inclination faces intersects the first direction and the second direction.

23. The projection imaging apparatus according to claim 17, wherein the display panel has at least a polarization element on the incident side of the sunlight, and the polarization element is provided on the inclination face of the prism.

24. The projection imaging apparatus according to claim 23, wherein the display panel is a liquid crystal panel, initial alignment of liquid crystal molecules in the liquid crystal panel is substantially parallel to the display face, the prism is provided on the display face such that the inclination direction of the inclination face and the initial alignment direction of the liquid crystal molecules intersect with each other based on the normal line of the display face, and the polarization element is provided on the inclination face such that an absorption axis is substantially the same as the initial alignment direction.
